(19) United States
(12) Patent Application Publication
(10) Pub. No.: US 2024/0113367 A1
(43) Pub. Date: Apr. 4, 2024

(54) METHOD FOR PRODUCING POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Tsuyoshi EHARA, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Shigeru MATSUMOTO, Toyohashi-shi (JP); Yasuaki NAGANO, Kosai-shi (JP)

(21) Appl. No.: 18/462,411

(22) Filed: Sep. 7, 2023

(30) Foreign Application Priority Data
Oct. 4, 2022 (JP) 2022-160187

(51) Int. Cl. H01M 50/169; H01M 50/103; H01M 50/15; H01M 50/176

(52) U.S. Cl. CPC H01M 50/169; H01M 50/103; H01M 50/15; H01M 50/176

(57) ABSTRACT

A method for producing a power storage device includes placing a lid assembly that includes a lid and a terminal member integrated therewith via a resin member to close an opening portion of a case body with the lid, and laser-welding the opening portion of the case body and the peripheral portion of the lid over an entire circumference. In placing the lid assembly, a peripheral high-level region, in which a peripheral outer surface of the peripheral portion of the lid is located on the outer side relative to an opening end surface of the opening portion of the case body is provided in proximate long-side opening portions, close of the opening portion and proximate long-side peripheral portions of the peripheral portion.

### CROSS-REFERENCE TO RELATED APPLICATIONS

This application is based upon and claims the benefit of priority to Japanese Patent Application No. 2022-160187 filed on Oct. 4, 2022, the entire contents of which are incorporated herein by reference.

### BACKGROUND

### Technical Field

The present disclosure relates to a method for producing a power storage device, such as a battery or a capacitor, in which a terminal member is fixed to a case via a resin member.

### Related Art

As a power storage device, there is known a rectangular battery in which positive and negative terminal members are each fixed to a case having a rectangular parallelepiped box-like shape with a resin member placed therebetween. Specifically, the case is composed of: a bottomed rectangular tube-shaped case body having an opening portion; and a plate-shaped lid which is laser-welded to the case body over the entire circumference to close the opening portion. In addition, the positive and negative terminal members are inserted individually in a pair of insertion holes formed in the lid and extend from the inside to the outside of the case. A pair of resin members are joined to the lid and the positive and negative terminal members while insulating between the lid and the terminal members. One example of the conventional art is disclosed in Japanese unexamined patent application publication No. 2021-086813 (see FIGS. 1 and 2, etc., of this publication No. 2021-086813).

### SUMMARY

### Technical Problems

However, in such a battery production process, the opening portion of the case body is closed with the lid to which the terminal members are fixed in advance, and the opening portion of the case body and a peripheral portion of the lid are laser-welded over the entire circumference. At this time, scattered light of a laser beam may be irradiated to the resin members, which insulate between the lid and the terminal members, thereby forming scorched portions on the resin members. Such a scorched portion is likely to be formed at a portion, of the resin member, which is close to a melt-solidified portion formed by laser-welding, specifically, at portions which are close to a pair of long-side opening portions of the rectangular ring-shaped opening portion of the case body and a pair of long-side peripheral portions of the rectangular ring-shaped peripheral portion of the lid.

The present disclosure has been made in view of such circumstances, and provides a method for producing a power storage device which can suppress formation of a scorched portion on a resin member insulating between a lid and a terminal member by scattered light of a laser beam when a case body and the lid are laser-welded to form a case.

### Means of Solving the Problems

(1) To achieve the above problems, one aspect of the present disclosure provides a method for producing a power storage device, the power storage device including: a case including: a case body that has a bottomed tube-shape and includes an opening portion having a rectangular ring shape and including a pair of long-side opening portions and a pair of short-side opening portions; and a lid that is laser-welded to the case body over an entire circumference to close the opening portion and includes a peripheral portion having a rectangular ring shape and including a pair of long-side peripheral portions and a pair of short-side peripheral portions; a terminal member inserted in an insertion hole that penetrates through the lid in a lid thickness direction; and a resin member joined to the terminal member and joined to an insertion hole surrounding portion of the lid, which surrounds the insertion hole, while insulating between the insertion hole surrounding portion of the lid and the terminal member, wherein the method comprises: placing a lid assembly that includes the lid and the terminal member integrated with the lid via the resin member, to close the opening portion of the case body with the lid so that the pair of long-side peripheral portions of the lid of the lid assembly faces the pair of long-side opening portions of the case body and the pair of short-side peripheral portions of the lid of the lid assembly faces the pair of short-side opening portions of the case body; and laser-welding the opening portion of the case body and the peripheral portion of the lid over the entire circumference to form the case by irradiating a laser beam from an outer side of the lid in the lid thickness direction so that the opening portion of the case body and the peripheral portion of the lid are melted and mixed and then solidified to form a melt-solidified portion, wherein in placing the lid assembly, a peripheral high-level region, in which a peripheral outer surface of the peripheral portion of the lid, facing the outer side, is located on the outer side relative to an opening end surface of the opening portion of the case body, facing the outer side, is provided in at least proximate long-side opening portions, close to the resin member, of the pair of long-side opening portions of the opening portion and at least proximate long-side peripheral portions, close to the resin member, of the pair of long-side peripheral portions of the peripheral portion, and in laser-welding the opening portion of the case body and the peripheral portion of the lid, the melt-solidified portion is formed such that the peripheral outer surface of the lid is located on the outer side relative to the melt-solidified portion in the peripheral high-level region.

In the above-described method for producing the power storage device, in the placing process, the lid assembly is placed on the case body so that the peripheral high-level region, in which the peripheral outer surface of the peripheral portion of the lid is located on the outer side in the lid thickness direction relative to the opening end surface of the opening portion of the case body, is provided in at least the proximate long-side opening portions of the opening portion of the case body and at least the proximate long-side peripheral portions of the peripheral portion of the lid. In the welding process, the melt-solidified portion is formed such that the peripheral outer surface of the lid is located on the outer side relative to the melt-solidified portion in the peripheral high-level region. Accordingly, in the welding process, in the peripheral high-level region, a molten metal portion is formed by irradiation of the laser beam to have an overall shape with a sloping surface that is lower as the distance from the resin member is larger. Therefore, scattered light of the laser beam irradiated to the sloping surface is less likely to be irradiated to the resin member, and hence the resin member is unlikely to be scorched or burned. In particular, formation of a scorched portion can be suppressed on peripheral proximity portions of the resin member, which are close to the proximate long-side opening portions and the proximate long-side peripheral portions and thus are likely to be scorched or burned. In addition, since the peripheral outer surface of the lid is located on the outer side relative to the melt-solidified portion in the peripheral high-level region, water and dust are less likely to be accumulated on the lid of the power storage device as compared to the case where a part of the melt-solidified portion is located on the outer side relative to the peripheral outer surface of the lid.

The peripheral high-level region may be provided over the entire circumference of the opening portion of the case body and the peripheral portion of the lid, or alternatively provided only for parts of the opening portion and the peripheral portion (including the proximate long-side opening portions and the proximate long-side peripheral portions).

The lid may include for example a plate-shaped lid, a lid having a shape in which a center portion excluding a peripheral portion bulges outward more than the peripheral portion, and a lid having a shape in which a center portion is recessed inward more than a peripheral portion.

The power storage device may include for example a secondary battery such as a lithium-ion secondary battery, a capacitor such as a lithium-ion capacitor, and an all-solid-state battery.

(2) Further, the above-described method for producing the power storage device described in (1) may be configured such that in placing the lid assembly, the peripheral high-level region is provided over an entire circumference of the opening portion of the case body and the peripheral portion of the lid, and in laser-welding the opening portion of the case body and the peripheral portion of the lid, the melt-solidified portion is formed such that the peripheral outer surface of the lid is located on the outer side relative to the melt-solidified portion over the entire circumference of the opening portion of the case body and the peripheral portion of the lid.

In the above-described method for producing the power storage device, the peripheral high-level region is provided over the entire circumference of the opening portion of the case body and the peripheral portion of the lid. Accordingly, during laser-welding, this configuration can prevent scattered light from any laser-irradiated position from being irradiated to the resin member, thus suppressing formation of a scorched portion over the entire circumference of the resin member. This configuration can further suppress accumulation of water and dust on the lid of the power storage device.

(3) Further, in the above-described method for producing the power storage device described in (1), the opening portion of the case body may have a form in which the proximate long-side opening portions are located on an inner side in the lid thickness direction relative to another portion of the opening portion.

In the above-described method for producing the power storage device, the case body having a form in which the proximate long-side opening portions of the opening portion are located on the inner side in the lid thickness direction relative to the other portion of the opening portion is used. By using such a case body, when the lid assembly is placed in the placing process, the above-described peripheral high-level region can be easily provided for the proximate long-side opening portions of the opening portion and the proximate long-side peripheral portions of the peripheral portion.

(4) Another aspect provides a power storage device comprising: a case including: a case body that has a bottomed tube-shape and includes an opening portion having a rectangular ring shape and including a pair of long-side opening portions and a pair of short-side opening portions; and a lid that is laser-welded to the case body over an entire circumference to close the opening portion and includes a peripheral portion having a rectangular ring shape and including a pair of long-side peripheral portions and a pair of short-side peripheral portions; a terminal member inserted in an insertion hole that penetrates through the lid in a lid thickness direction; and a resin member joined to the terminal member and joined to an insertion hole surrounding portion of the lid, which surrounds the insertion hole, while insulating between the insertion hole surrounding portion of the lid and the terminal member, wherein of the opening portion of the case body and the peripheral portion of the lid, for at least proximate long-side opening portions, close to the resin member, of the pair of long-side opening portions and at least proximate long-side peripheral portions, opposing the proximate long-side opening portions and close to the resin member, of the pair of long-side peripheral portions, a peripheral outer surface of the peripheral portion, facing an outer side in the lid thickness direction, is located on the outer side relative to a melt-solidified portion which is a portion solidified after the opening portion and the peripheral portion are melted and mixed.

In the above-described power storage device, since formation of a scorched portion is suppressed on the peripheral proximity portions, of the resin member, which are close to the proximate long-side opening portions and the proximate long-side peripheral portions and thus are likely to be formed with a scorched portion, the resin member can maintain its original appearance, and hence prevent a decrease in the insulation resistance between the lid and the terminal member through a formed scorched portion. In addition, at the proximate long-side opening portions and the proximate long-side peripheral portions, the peripheral outer surface of the lid is located on the outer side relative to the melt-solidified portion, so that water and dust are less likely to be accumulated on the lid of the power storage device as compared to the case where a part of the melt-solidified portion is located on the outer side relative to the peripheral outer surface of the lid.

(5) Further, in the power storage device described in (4), the peripheral outer surface of the lid may be located on the outer side relative to the melt-solidified portion over an entire circumference of the opening portion of the case body and the peripheral portion of the lid.

In the above-described power storage device, since formation of a scorched portion is suppressed over the entire circumference of the resin member, the resin member can maintain its original appearance over the entire circumference, and hence prevent a decrease in the insulation resistance between the lid and the terminal member through a formed scorched portion. In addition, accumulation of water and dust on the lid of the power storage device can be further suppressed.

### BRIEF DESCRIPTION OF THE DRAWINGS

FIG. 1 is a perspective view of a battery in a first embodiment;

FIG. 2 is a cross-sectional view of the battery in the first embodiment, taken along a battery height direction and a battery width direction;

FIG. 3A is a partially enlarged cross-sectional view of an area around an opening portion of a case body and a peripheral portion of a lid of the battery in the first embodiment, taken along the battery height direction and the battery width direction;

FIG. 3B is a partially enlarged cross-sectional view of the area around the opening portion of the case body and the peripheral portion of the lid of the battery in the first embodiment, taken along the battery height direction and a battery thickness direction;

FIG. 4 is a flowchart of a method for producing the battery in the first embodiment;

FIG. 5 is a view related to the method for producing the battery in the first embodiment, illustrating a lid assembly formed in a lid assembly forming step;

FIG. 6 is a view related to the method for producing the battery in the first embodiment, showing that the lid assembly is placed such that the opening portion of the case body is closed with the lid included in the lid assembly in a placing step;

FIGS. 7A and 7B are views related to the method for producing the battery in the first embodiment, showing that the opening portion (a proximate long-side opening portion) of the case body and the peripheral portion (a proximate long-side peripheral portion) of the lid are laser-welded in a welding step, and respectively showing that irradiation of a laser beam is started and that a molten metal portion is formed by irradiation of the laser beam;

FIGS. 8A and 8B are respectively a side view and a top view of a case body of a battery in a second embodiment; and

FIGS. 9A and 9B are views related to a method for producing a battery according to a comparative embodiment, corresponding to FIGS. 7A and 7B, and respectively showing that irradiation of a laser beam is started and that a molten metal portion is formed by irradiation of the laser beam.

### DETAILED DESCRIPTION OF THE EXEMPLARY EMBODIMENTS

### First Embodiment

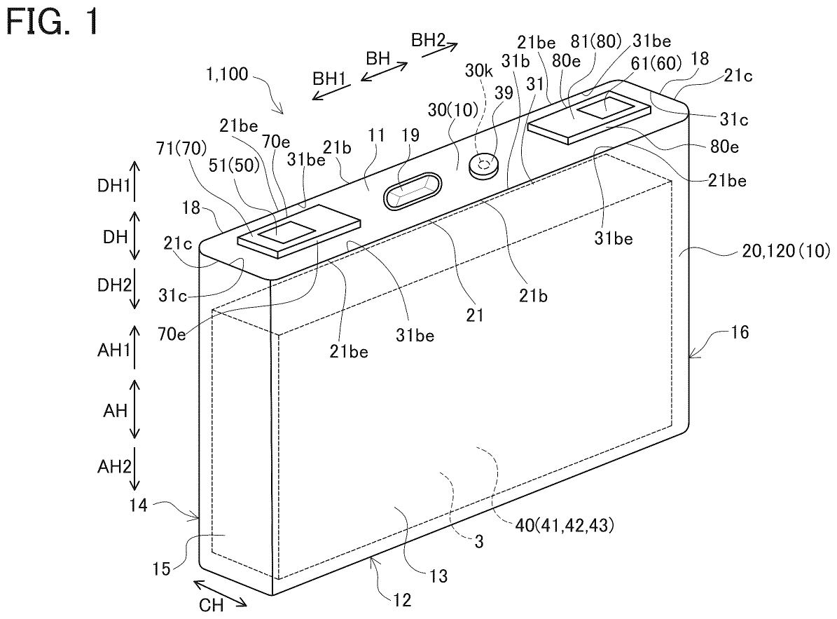

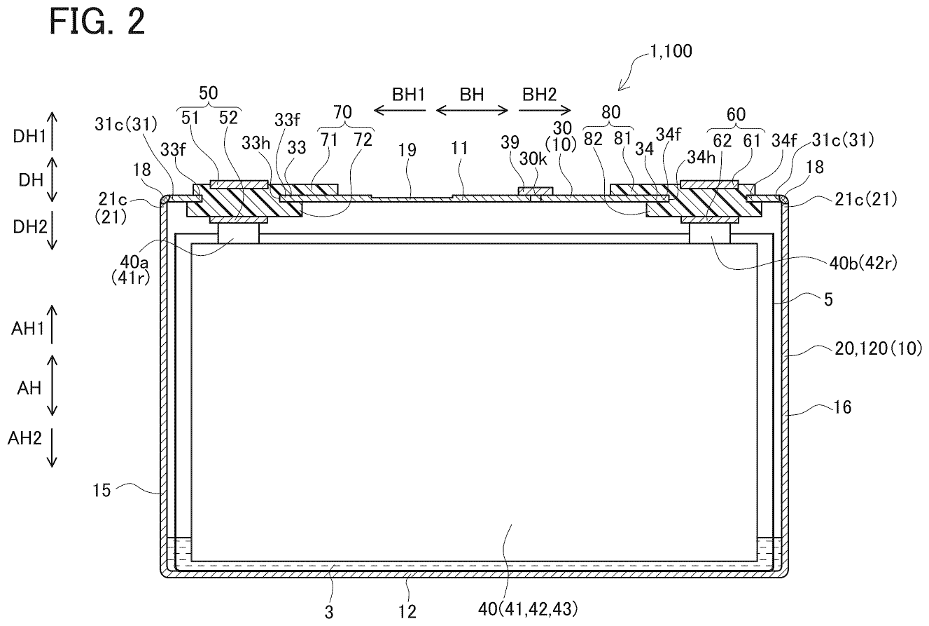

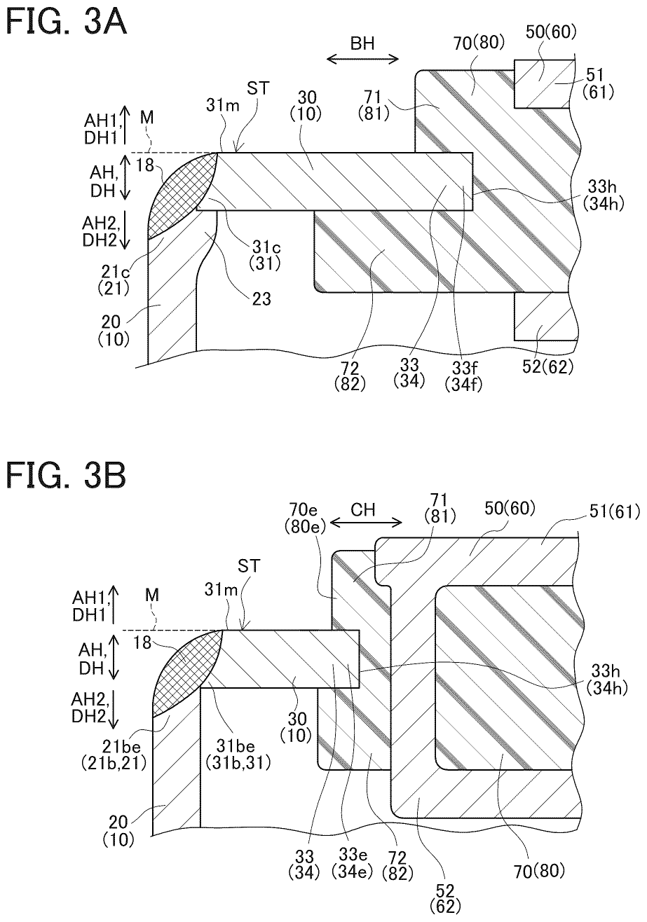

Hereinafter, a first embodiment of the present disclosure will be described with reference to the drawings. FIG. 1 is a perspective view of a battery (one example of a power storage device of the present disclosure) 1 in the first embodiment. FIG. 2 is a cross-sectional view of the whole battery 1. FIGS. 3A and 3B are partially enlarged cross-sectional views of an area around an opening portion 21 of a case body 20 and a peripheral portion 31 of a lid 30 of the battery 1. The following description will be given with a battery height direction AH, a battery width direction BH, and a battery thickness direction CH of the battery 1 being defined as directions shown in FIGS. 1 to 3B. The battery 1 is a rectangular (rectangular parallelepiped-shaped) sealed lithium-ion secondary battery, which will be mounted in a vehicle, such as a hybrid car, a plug-in hybrid car, or an electric car.

The battery 1 includes a case 10, an electrode body 40 housed in the case 10, a positive terminal member 50 and a negative terminal member 60 each supported on a case top part 11 of the case 10 via resin members 70 and 80, and others. In the case 10, the electrode body 40 is covered with a bag-shaped insulating holder 5 which is composed of an insulating film and which is open on an upper side AH1 in the battery height direction AH. In addition, the case contains an electrolyte 3, a part of which is impregnated in the electrode body and the rest is accumulated on a case bottom part 12 of the case 10.

The case 10 is made of a metal (aluminum in the present embodiment) in a rectangular parallelepiped box-like shape, and includes the rectangular case top part 11 located on the upper side AH1 in the battery height direction AH, the rectangular case bottom part 12 opposed to the case top part 11 and located on a lower side AH2 in the battery height direction AH, and four rectangular case side wall parts (a pair of case long-side parts 13 and 14 and a pair of case short-side parts 15 and 16) connecting those top part 11 and bottom part 12.

The case 10 includes the case body 20 and the lid 30. The case body has a bottomed rectangular tube shape and includes the opening portion 21 having a rectangular ring shape and including a pair of long-side opening portions 21b and a pair of short-side opening portions 21c on the upper side AH1 in the battery height direction AH, and forms the case bottom part 12, the case long-side parts 13 and 14, and the case short-side parts 15 and 16 of the case 10. Meanwhile, the lid 30 has a rectangular plate shape, including the peripheral portion 31 having a rectangular ring shape, and forms the case top part 11 of the case 10. The lid 30 is laser-welded to the case body 20 over the entire circumference to close the opening portion 21 of the case body 20, and accordingly a melt-solidified portion 18 is formed between the lid 30 and the case body 20.

Specifically, a pair of long-side opening portions 21b of the rectangular ring-shaped opening portion 21 of the case body 20 and a pair of long-side peripheral portions 31b of the rectangular ring-shaped peripheral portion 31 of the lid 30 are welded to each other to form the melt-solidified portion 18 (see FIG. 3B). Also, a pair of short-side opening portions 21c of the opening portion 21 of the case body 20 and a pair of short-side peripheral portions 31c of the peripheral portion 31 of the lid 30 are welded to each other to form the melt-solidified portion 18 (see FIG. 3A). In the first embodiment, a peripheral outer surface 31m of the peripheral portion 31, facing outward, i.e., an outer side DH1 in a lid thickness direction DH (the upper side AH1 in the battery height direction AH), is located on the outer side DH1 (the upper side AH1) relative to, i.e., more than, the melt-solidified portion 18 over the entire circumference of the opening portion 21 and the peripheral portion 31 including proximate long-side opening portions 21be of the pair of long-side opening portions 21b, close to the resin members 70 and 80, and proximate long-side peripheral portions 31be of the pair of long-side peripheral portions 31b, close to the resin members 70 and 80. The position of the peripheral outer surface 31m in the lid thickness direction DH is indicated by a broken line M in FIGS. 3A and 3B.

The lid 30 is provided with a safety valve 19 which breaks and opens when the internal pressure of the case 10 exceeds a valve opening pressure. The lid 30 also has a liquid inlet 30k formed so as to communicate between the inside and the outside of the case 10, and the liquid inlet 30k is hermetically sealed with a disc-shaped sealing member 39 made of aluminum. The lid 30 is provided with rectangular insertion holes 33h and 34h located near an end portion on one side BH1 and near an end portion on the other side BH2 in the battery width direction BH, respectively, and penetrating in a lid thickness direction DH. The positive terminal member 50 made of aluminum is inserted in the insertion hole 33h and fixed to the lid 30 via the resin member 70 so that the terminal member 50 is insulated from the lid 30. In addition, the negative terminal member 60 made of copper is inserted in the other insertion hole 34h and fixed to the lid 30 via the resin member 80 so that the terminal member 60 is insulated from the lid 30.

These terminal members 50 and 60 respectively have rectangular plate-shaped outer terminal portions 51 and 61 placed on the lid 30, and inner terminal portions 52 and 62 placed mainly inside the case 10 and continuous to the outer terminal portions 51 and 61 through the insides of the insertion holes 33h and 34h of the lid 30. The positive inner terminal portion 52 is joined and electrically conductive to a positive electrode tab 40a of the electrode body 40 in the case 10. Meanwhile, the negative inner terminal portion 62 is joined and electrically conductive to a negative electrode tab 40b of the electrode body 40 in the case 10.

The resin member 70 is joined to the positive terminal member 50 and a rectangular ring-shaped insertion hole surrounding portion 33, which surrounds the insertion hole 33h of the lid 30 and which has a pair of long-side surrounding portions 33e and a pair of short-side surrounding portions 33f, while insulating between the insertion hole surrounding portion 33 of the lid 30 and the positive terminal member 50. Similarly, the resin member 80 is joined to the negative terminal member 60 and a rectangular ring-shaped insertion hole surrounding portion 34, which surrounds the insertion hole 34h of the lid 30 and which has a pair of long-side surrounding portions 34e and a pair of short-side surrounding portions 34f, while insulating between the insertion hole surrounding portion 34 of the lid 30 and the negative terminal member 60.

These resin members 70 and 80 are made of polyphenylene sulfide (PPS), and respectively have rectangular plate-shaped outer insulating portions 71 and 81 placed on the lid 30, and inner insulating portions 72 and 82 placed inside the case 10 and in the insertion holes 33h and 34h of the lid 30 and continuous to the outer insulating portions 71 and 81. The outer insulating portions 71 and 81 insulate between the outer terminal portions 51 and 61 of the terminal members 50 and 60 and the insertion hole surrounding portions 33 and 34 of the lid 30, respectively. Meanwhile, the inner insulating portions 72 and 82 insulate between the inner terminal portions 52 and 62 of the terminal members 50 and 60 and the insertion hole surrounding portions 33 and 34 of the lid 30, respectively.

The electrode body 40 is a laminated electrode body having a flat, rectangular parallelepiped box-like shape, in which a plurality of positive electrode plates 41 and a plurality of negative electrode plates 42, each having a rectangular shape and extending in the battery height direction AH and the battery width direction BH, are alternately stacked in the battery thickness direction CH with separators 43 composed of a porous resin membrane interposed therebetween. Each of the positive electrode plates 41 has a positive current collecting portion 41r extending upward on the upper side AH1, and the respective positive current collecting portions 41r overlap each other in the thickness direction thereof to form the above-described positive electrode tab 40a. The positive electrode tab 40a is connected to the inner terminal portion 52 of the positive terminal member 50 as described above. In addition, each if the negative electrode plates 42 has a negative current collecting portion 42r extending upward on the upper side AH1, and the respective negative current collecting portions 42r overlap each other in the thickness direction thereof to form the above-described negative electrode tab 40b. The negative electrode tab 40b is connected to the inner terminal portion 62 of the negative terminal member 60 as described above.

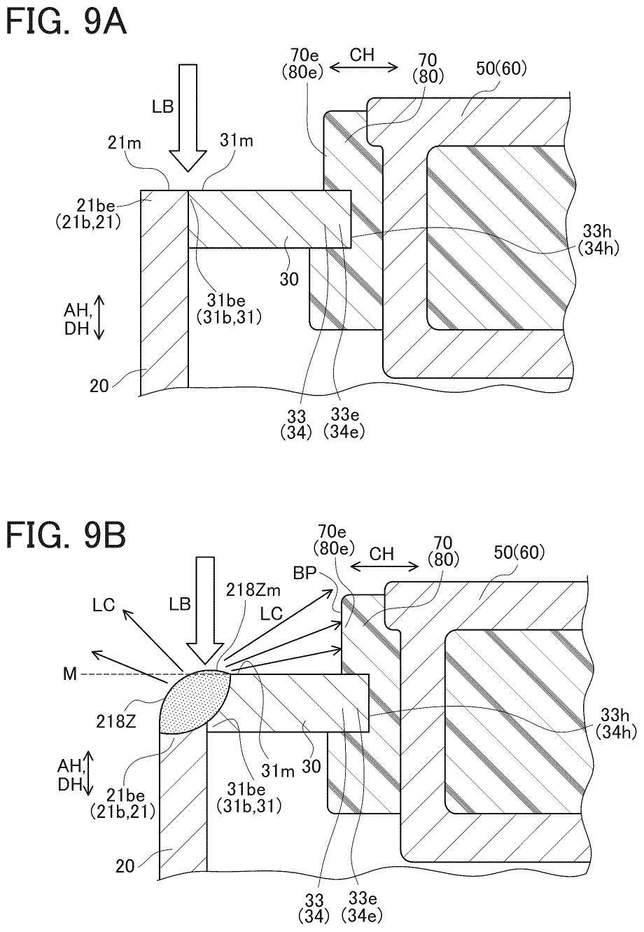

The battery 1 in the first embodiment is configured to suppress formation of a scorched portion BP on peripheral proximity portions 70e and 80e (see FIG. 3B) of the resin members 70 and 80, which are close to the proximate long-side opening portions 21be and the proximate long-side peripheral portions 31be and accordingly are likely to be formed with a scorched portion BP (see FIG. 9B). Further, this configuration can also prevent formation of a scorched portion BP over the entire circumference of the resin members 70 and 80. Therefore, the resin members 70 and 80 can maintain their original appearance over the entire circumference thereof, and hence prevent a decrease in the insulation resistance between the lid 30 and the terminal members 50 and 60 through a formed scorched portion BP.

In the first embodiment, in the proximate long-side opening portions 21be and the proximate long-side peripheral portions 31be, furthermore, over the entire circumference of the opening portion 21 and the peripheral portion 31, the peripheral outer surface 31m of the lid 30 is located on the outer side DH1 relative to the melt-solidified portion 18. Therefore, water and dust are less likely to be accumulated on the lid 30 (case top part 11) of the battery 1.

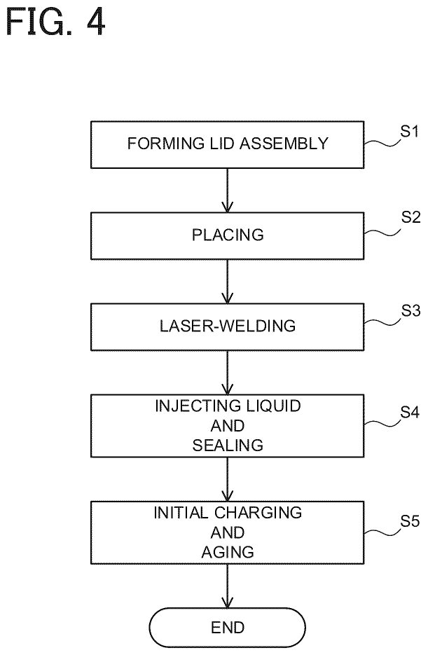

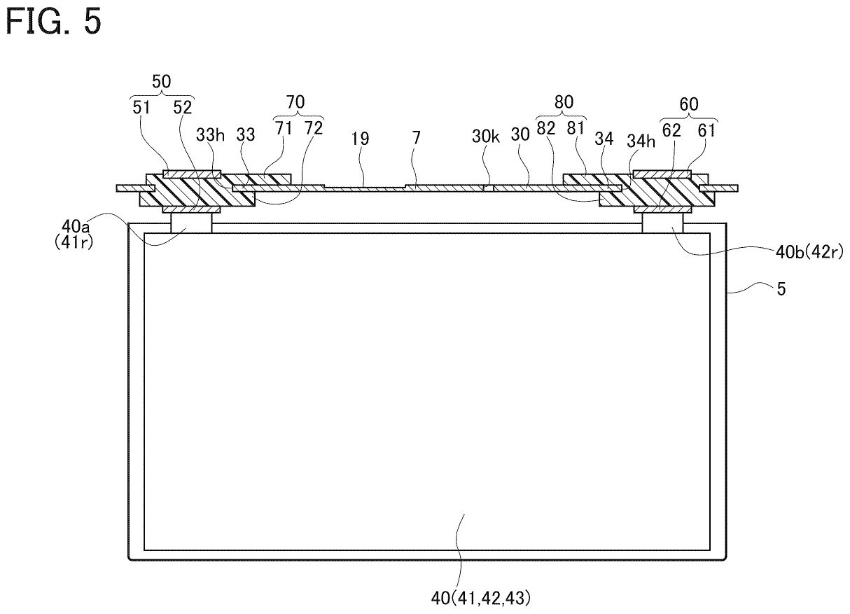

Next, a method for producing the battery 1 configured as above will be described below (see FIGS. 4 to 7B). First, in a lid assembly forming step S1 (see FIG. 4), a lid assembly 7 is formed (see FIG. 5). That is, the lid 30 and the terminal members 50 and 60 are prepared, and the resin members 70 and 80 are formed by insert-molding to integrate the terminal members 50 and 60 with the lid 30 via the resin members 70 and 80 respectively. Specifically, the lid 30 is produced from an aluminum plate by press working, simultaneously forming the liquid inlet 30k, the insertion holes 33h and 34h, and the safety valve 19 in the aluminum plate. In addition, the positive terminal member 50 is produced from an aluminum plate by press working, and the negative terminal member 60 is produced from a copper plate by press working. Then, with the terminal members 50 and 60 inserted in the insertion holes 33h and 34h of the lid 30, the resin members 70 and 80 are formed by insert-molding to integrate the terminal members 50 and 60 with the lid 30 via the resin members 70 and 80.

Then, the electrode body 40 formed by stacking the positive electrode plates 41, the negative electrode plates 42, and the separators 43 is prepared, and the inner terminal portions 52 and 62 of the terminal members 50 and 60 integrated with the lid 30 are welded and connected to the positive electrode tab 40a and the negative electrode tab 40b of the electrode body 40, respectively. Further, the electrode body 40 is enclosed in the bag-shaped insulating holder 5. Thus, the lid assembly 7 which is composed of the lid 30, the terminal members 50 and 60, the resin members 70 and 80, the electrode body 40, and the insulating holder 5 is completed.

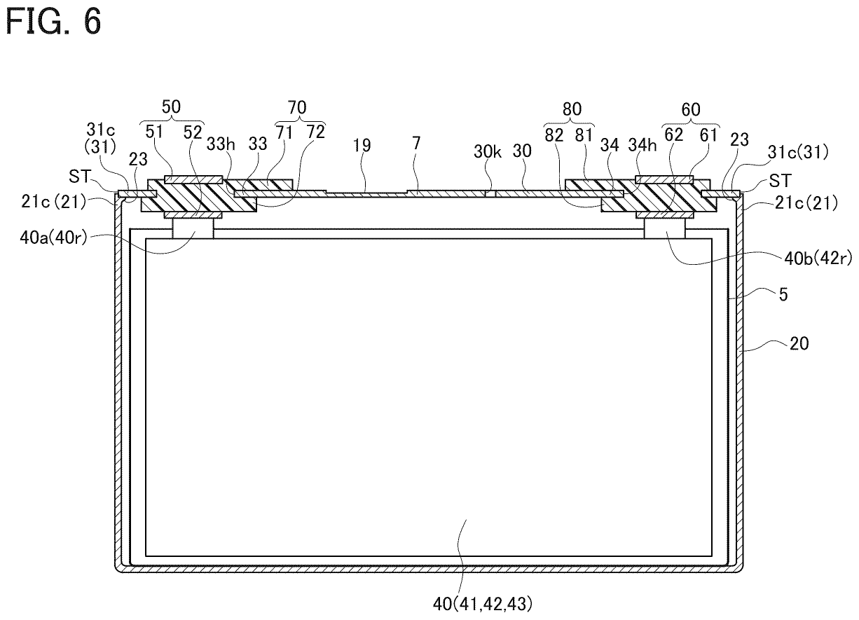

In a placing step S2 (see FIG. 4), the case body 20 is prepared, the electrode body 40, covered with the insulating holder 5, of the lid assembly 7 is inserted into the case body 20, and the lid assembly 7 is placed on the case body such that the opening portion 21 of the case body 20 is closed with the lid 30 (see FIG. 6). Specifically, the lid 30 is placed to close the opening portion 21 of the case body 20 so that the pair of long-side peripheral portions 31b of the peripheral portion 31 of the lid 30 faces the pair of long-side opening portions 21b of the opening portion 21 of the case body 20, and the pair of short-side peripheral portions 31c of the peripheral portion 31 of the lid 30 faces the pair of short-side opening portions 21c of the opening portion 21 of the case body 20.

At this time, a peripheral high-level region ST is provided in which the peripheral outer surface 31m, facing the outer side DH1 in the lid thickness direction DH (the upper side AH1 in the battery height direction AH), of the peripheral portion 31 of the lid 30 is located on the outer side DH1 relative to, i.e., more outward than, an opening end surface 21m, facing the outer side DH1, of the opening portion 21 of the case body 20. In the first embodiment, the peripheral high-level region ST is provided over the entire circumference of the opening portion 21 of the case body 20 and the peripheral portion 31 of the lid 30. Specifically, the case body 20 is provided with shelf portions 23 (see FIGS. 6 and 3A), which engage the lid 30, at a position on the outer side DH1 (the upper side AH1) compared to that in the conventional art. Thus, the whole lid 30 is placed on the outer side DH1 with the peripheral outer surface 31m of the peripheral portion 31 located on the outer side DH1 relative to the opening end surface 21m of the opening portion 21 of the case body 20 over the entire circumference.

Instead of providing the above-described shelf portions 23 of the case body 20 on the outer side DH1, the thickness of the lid 30 may be made larger than that in the conventional art, whereby the whole lid 30 may be placed on the outer side DH1 to provide the peripheral high-level region ST over the entire circumference.

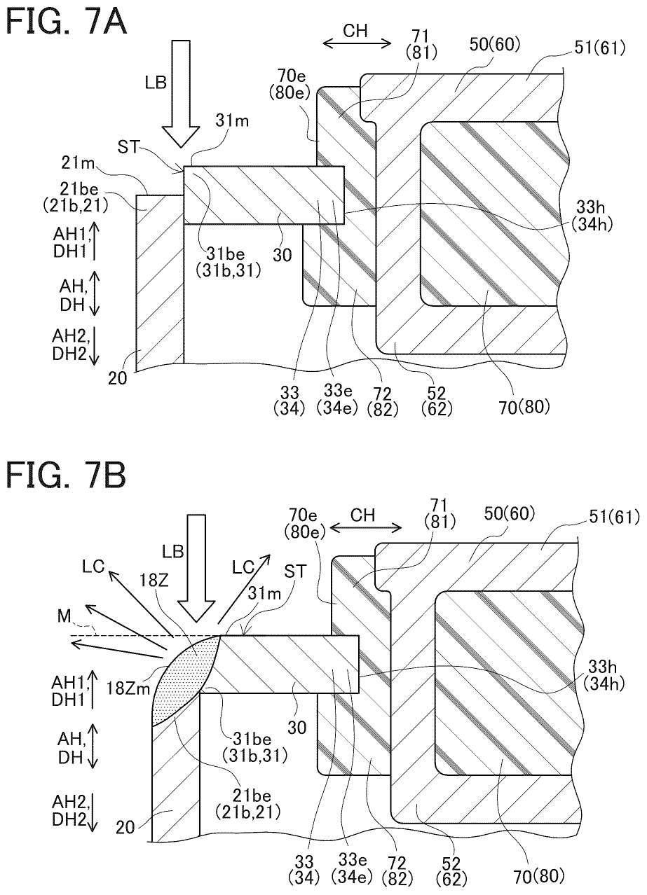

In a welding step S3 (see FIG. 4), laser welding is performed over the entire circumference of the lid 30 by irradiating a laser beam LB onto the opening portion 21 of the case body 20 and the peripheral portion 31 of the lid 30 from above on an outer side DH1 in the lid thickness direction DH of the lid 30 (i.e., the upper side AH1 in the battery height direction AH) to melt and mix the opening portion 21 and the peripheral portion 31 to form a molten metal portion 18Z, and the molten metal portion 18Z is then solidified, forming the melt-solidified portion 18 to complete the case 10 (see FIGS. 7A and 7B).

Here, FIGS. 9A and 9B show a comparative embodiment, in which the above-described peripheral high-level region ST is not provided in the placing step S2, and thus the peripheral outer surface 31m of the peripheral portion 31 of the lid 30 and the opening end surface 21m of the opening portion 21 of the case body 20 are located at the same height, i.e., are flush with each other. In this case, a part of a molten metal portion 218Z is located on the outer side DH1 in the lid thickness direction DH relative to the peripheral outer surface 31m of the lid 30 (the part of the molten metal portion 218Z is located above a broken line M in FIG. 9B), and the molten metal portion 218Z has a shape having a sloping surface 218Zm which is lower at a smaller distance from the resin members 70 and 80, i.e., toward the right in FIG. 9B. The thus shaped molten metal portion 218Z likely causes scattered light LC of the laser beam LB irradiated to the sloping surface 218Zm to travel to the resin members 70 and 80, which may cause formation of a scorched portion BP on the resin members 70 and 80.

In particular, the resin members 70 and 80 provided to the lid 30 are close to parts of the long-side opening portions 21b of the opening portion 21 of the case body 20, that is, the proximate long-side opening portions 21be, and parts of the long-side peripheral portions 31b of the peripheral portion 31 of the lid 30, that is, the proximate long-side peripheral portions 31be. Therefore, the scattered light LC having high intensity is irradiated to the peripheral proximity portions 70e and 80e of the resin members 70 and 80, which are opposite and close to the proximate long-side opening portions 21be of the opening portion 21 and the proximate long-side peripheral portions 31be of the peripheral portion 31, so that a scorched portion BP is particularly likely to be formed thereat.

In contrast, in the present embodiment (see FIGS. 7A and 7B), the peripheral outer surface 31m of the lid 30 is located on the outer side DH1 in the lid thickness direction DH relative to, or more outward than, the molten metal portion 18Z (the entire molten metal portion 18Z is located below a broken line M in FIG. 7B), and the molten metal portion 18Z has an overall shape having a sloping surface 18Zm that is lower at a larger distance from the resin members 70 and 80, i.e., toward the left in FIG. 7B. The thus shaped molten metal portion 18Z is less likely to cause the scattered light LC of the laser beam LB irradiated to the sloping surface 18Zm to travel to the resin members 70 and 80, and therefore can prevent formation of a scorched portion BP on the resin members 70 and 80.

In a liquid injecting and sealing step S4, subsequently, the electrolyte 3 is injected into the case 10 through the liquid inlet 30k so that the electrode body 40 is impregnated therewith. Then, the liquid inlet 30k is covered with the sealing member 39 from the outside, and the sealing member 39 is welded to the lid 30 over the entire circumference to hermetically seal between the sealing member 39 and the lid 30.

In an initial charging and aging step S5, a charging device (not shown) is connected to the battery 1, and initial charging is performed on the battery 1. Then, the initially charged battery 1 is allowed to stand for a predetermined time to age the battery 1. Thus, the battery 1 is completed.

In the method for producing the battery 1 of the present embodiment, in the placing step S2, the lid assembly 7 is placed on the case body 20, thereby providing the peripheral high-level region ST in which the peripheral outer surface 31m of the peripheral portion 31 of the lid 30 is located on the outer side DH1 in the lid thickness direction DH relative to the opening end surface 21m of the opening portion 21 of the case body 20, for the proximate long-side opening portions 21be of the opening portion 21 of the case body 20 and the proximate long-side peripheral portions 31be of the peripheral portion 31 of the lid 30. In the welding step S3, the melt-solidified portion 18 is formed such that the peripheral outer surface 31m of the lid 30 is located on the outer side DH1 relative to the molten metal portion 18Z (the melt-solidified portion 18) in the peripheral high-level region ST.

Accordingly, in the welding step S3, in the peripheral high-level region ST, the molten metal portion 18Z formed by irradiation of the laser beam LB is shaped with the sloping surface 18Zm becoming lower as the distance from the resin members 70 and 80 is larger. The thus shaped molten metal portion 18Z is less likely to cause scattered light LC of the laser beam LB irradiated to the sloping surface 18Zm to travel to the resin members 70 and 80, and therefore can prevent formation of a scorched portion BP on the resin members 70 and 80. In particular, this configuration can suppress formation of a scorched portion BP on the peripheral proximity portions 70e and 80e where a scorched portion BP is likely to be formed.

Since the peripheral outer surface 31m of the lid 30 is located on the outer side DH1 relative to the melt-solidified portion 18 in the peripheral high-level region ST, water and dust are less likely to be accumulated on the lid 30 (the top part 11) of the battery 1 as compared to the case where a part of the melt-solidified portion (e.g., the molten metal portion 218Z) is located on the outer side DH1 relative to the peripheral outer surface 31m of the lid 30 as in the comparative embodiment.

Furthermore, in the first embodiment, the peripheral high-level region ST is provided over the entire circumference of the opening portion 21 of the case body 20 and the peripheral portion 31 of the lid 30. Accordingly, during laser-welding, this configuration can prevent scattered light LC from any laser-irradiated position from being irradiated to the resin members 70 and 80, thus suppressing formation of a scorched portion BP over the entire circumference of the resin members 70 and 80. This configuration can further suppress accumulation of water and dust on the lid 30 of the battery 1.

### Second Embodiment

Next, a second embodiment will be described. In the following description, parts identical or similar to those in the first embodiment are omitted or simplified. In the method for producing the battery 1 in the first embodiment, in the placing step S2, the peripheral high-level region ST in which the peripheral outer surface 31m of the peripheral portion 31 is located on the outer side DH1 relative to the opening end surface 21m of the opening portion 21 is provided over the entire circumference of the opening portion 21 of the case body 20 and the peripheral portion 31 of the lid 30. In contrast, a method for producing a battery 100 in the second embodiment differs from the first embodiment in that, in the placing step S2, the peripheral high-level region ST is provided only for parts of an opening portion 121 of a case body 120 and the peripheral portion 31 of the lid 30, that is, proximate long-side opening portions 121be and proximate long-side peripheral portions 31be.

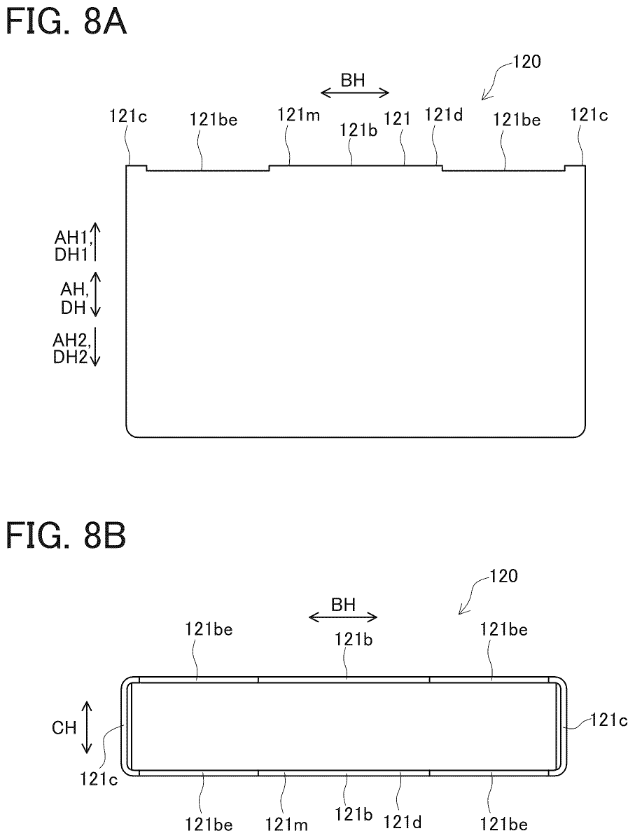

Specifically, the second embodiment uses the case body 120 different from the case body 20 used in the first embodiment in the shape of the opening portion 121 (see FIGS. 8A and 8B). That is, the opening portion 121 of the case body 120 in the second embodiment has a rectangular ring shape having a pair of long-side opening portions 121b and a pair of short-side opening portions 121c. However, the opening portion 121 has a shape in which the proximate long-side opening portions 121be of the long-side opening portions 121b are located on an inner side DH2 in the lid thickness direction DH (the lower side AH2 in the battery height direction AH) relative to other portions 121d (parts of the long-side opening portions 121b other than the proximate long-side opening portions 121be, and the short-side opening portions 121c) of the opening portion 121, specifically, a shape formed with four cutouts in the opening portion 121.

In the placing step S2 in the second embodiment, the lid assembly 7 is placed on the case body 120, thereby providing the peripheral high-level region ST in which the peripheral outer surface 31m of the peripheral portion 31 is located on the outer side DH1 relative to an opening end surface 121m of the opening portion 121 is provided only for the proximate long-side opening portions 121be of the opening portion 121 of the case body 120 and the proximate long-side peripheral portions 31be of the peripheral portion 31 of the lid 30.

Then, when the opening portion 121 of the case body 120 and the peripheral portion 31 of the lid 30 are laser-welded in the welding step S3, the peripheral outer surface 31m of the lid 30 is located on the outer side DH1 in the lid thickness direction DH relative to the molten metal portion 18Z in the peripheral high-level region ST, and the molten metal portion 18Z is shaped with the sloping surface 18Zm becoming lower as the distance from the resin members 70 and 80 is larger, as described in the first embodiment (see FIG. 7B). Therefore, the scattered light LC of the laser beam LB irradiated to the sloping surface 18Zm is less likely to be applied to the peripheral proximity portions 70e and 80e of the resin members 70 and 80, so that formation of the scorched portion BP on the peripheral proximity portions 70e and 80e can be suppressed.

In contrast, in the portions of the opening portion 121 of the case body 120 and the peripheral portion 31 of the lid 30, for which the peripheral high-level region ST is not provided, a part of the molten metal portion 218Z is located on the outer side DH1 in the lid thickness direction DH relative to the peripheral outer surface 31m of the lid 30, and the molten metal portion 218Z is shaped with the sloping surface 218Zm becoming lower as the distance from the resin members 70 and 80 is smaller, as described in the comparative embodiment (see FIGS. 9A and 9B). Therefore, the scattered light LC of the laser beam LB irradiated to the sloping surface 218Zm is likely to be applied to the resin members 70 and 80. However, the distances from the opening portion 121 and the peripheral portion 31 to the resin members 70 and 80 are sufficiently long at the portions for which the peripheral high-level region ST is not provided. Therefore, the scattered light LC having high intensity is not irradiated to the resin members 70 and 80, and thus a scorched portion BP is less likely to be formed on the resin members 70 and 80.

In the method for producing the battery 100 in the second embodiment as well, in the placing step S2, the peripheral high-level region ST in which the peripheral outer surface 31m of the peripheral portion 31 of the lid 30 is located on the outer side DH1 relative to the opening end surface 121m of the opening portion 121 of the case body 120 is provided for the proximate long-side opening portions 121be of the opening portion 121 and the proximate long-side peripheral portions 31be of the peripheral portion 31. Therefore, in the peripheral high-level region ST, the scattered light LC of the laser beam LB is less likely to be irradiated to the resin members 70 and 80, so that the scorched portion BP is less likely to be formed at the resin members 70 and 80. In particular, formation of the scorched portion BP can be suppressed on the peripheral proximity portions 70e and 80e where a scorched portion BP is likely to be formed. In addition, since the peripheral outer surface 31m of the lid 30 is located on the outer side DH1 relative to the melt-solidified portion 18 in the peripheral high-level region ST, water and dust are less likely to be accumulated on the lid 30 of the battery 100.

In the second embodiment, the case body 120 used therein has a shape in which the proximate long-side opening portions 121be of the opening portion 121 are located on the inner side DH2 in the lid thickness direction DH relative to the other portions 121d of the opening portion 121. Thus, when the lid assembly 7 is placed in the placing step S2, the peripheral high-level region ST can be easily provided for the proximate long-side opening portions 121be of the opening portion 121 and the proximate long-side peripheral portions 31be of the peripheral portion 31. In addition, similar or identical parts those in the first embodiment can achieve the same effects as in the first embodiment.

While the present disclosure has been described above based on the first and second embodiments, it should be understood that the present disclosure is not limited to the first and second embodiments but can be applied with modifications appropriately made thereto without departing from the scope of the gist of the present disclosure.

For example, in the first and second embodiments, the laminated electrode body 40 is exemplified as the electrode body housed in the case 10, but the electrode body may be a flat wound electrode body. In a single case, a plurality of electrode bodies may be housed together.

### REFERENCE SIGNS LIST

1 Battery (Power storage device)
7 Lid assembly
10 Case
18 Melt-solidified portion
20, 120 Case body
21, 121 Opening portion
21m, 121m Opening end surface
21b, 121b Long-side opening portion
21be, 121be Proximate long-side opening portion
21c, 121c Short-side opening portion
121d Other portion
30 Lid
31 Peripheral portion
31m Peripheral outer surface
31b Long-side peripheral portion
31be Proximate long-side peripheral portion
31c Short-side peripheral portion
33, 34 Insertion-hole surrounding portion
33h, 34h Insertion hole
40 Electrode body
50, 60 Terminal member
70, 80 Resin member
70e, 80e Peripheral proximity portion (of resin member)
DH Lid thickness direction
DH1 Outer side (in lid thickness direction)
DH2 Inner side (in lid thickness direction)
LB Laser beam
LC Scattered light
ST Peripheral high-level region
S1 Lid assembly forming step
S2 Placing step
S3 Welding step
S4 Liquid injecting and sealing step
S5 Initial charging and aging step

What is claimed is:

1. A method for producing a power storage device,
the power storage device including:
a case including:
a case body that has a bottomed tube-shape and includes an opening portion having a rectangular ring shape and including a pair of long-side opening portions and a pair of short-side opening portions; and
a lid that is laser-welded to the case body over an entire circumference to close the opening portion and includes a peripheral portion having a rectangular ring shape and including a pair of long-side peripheral portions and a pair of short-side peripheral portions;
a terminal member inserted in an insertion hole that penetrates through the lid in a lid thickness direction; and
a resin member joined to the terminal member and joined to an insertion hole surrounding portion of the lid, which surrounds the insertion hole, while insulating between the insertion hole surrounding portion of the lid and the terminal member,
wherein the method comprises:
placing a lid assembly that includes the lid and the terminal member integrated with the lid via the resin member, to close the opening portion of the case body with the lid so that the pair of long-side peripheral portions of the lid of the lid assembly faces the pair of long-side opening portions of the case body and the pair of short-side peripheral portions of the lid of the lid assembly faces the pair of short-side opening portions of the case body; and
laser-welding the opening portion of the case body and the peripheral portion of the lid over the entire circumference to form the case by irradiating a laser beam from an outer side of the lid in the lid thickness direction so that the opening portion of the case body and the peripheral portion of the lid are melted and mixed and then solidified to form a melt-solidified portion, wherein
in placing the lid assembly,
a peripheral high-level region, in which a peripheral outer surface of the peripheral portion of the lid, facing the outer side, is located on the outer side relative to an opening end surface of the opening portion of the case body, facing the outer side, is provided in at least proximate long-side opening portions, close to the resin member, of the pair of long-side opening portions of the opening portion and at least proximate long-side peripheral portions, close to the resin member, of the pair of long-side peripheral portions of the peripheral portion, and
in laser-welding the opening portion of the case body and the peripheral portion of the lid,
the melt-solidified portion is formed such that the peripheral outer surface of the lid is located on the outer side relative to the melt-solidified portion in the peripheral high-level region.

2. The method for producing the power storage device according to claim 1, wherein
in placing the lid assembly,
the peripheral high-level region is provided over an entire circumference of the opening portion of the case body and the peripheral portion of the lid, and
in laser-welding the opening portion of the case body and the peripheral portion of the lid,
the melt-solidified portion is formed such that the peripheral outer surface of the lid is located on the outer side relative to the melt-solidified portion over the entire circumference of the opening portion of the case body and the peripheral portion of the lid.

3. The method for producing the power storage device according to claim 1, wherein the opening portion of the case body has a form in which the proximate long-side opening portions are located on an inner side in the lid thickness direction relative to another portion of the opening portion.

4. A power storage device comprising:
a case including:
a case body that has a bottomed tube-shape and includes an opening portion having a rectangular ring shape and including a pair of long-side opening portions and a pair of short-side opening portions; and
a lid that is laser-welded to the case body over an entire circumference to close the opening portion and includes a peripheral portion having a rectangular ring shape and including a pair of long-side peripheral portions and a pair of short-side peripheral portions;
a terminal member inserted in an insertion hole that penetrates through the lid in a lid thickness direction; and
a resin member joined to the terminal member and joined to an insertion hole surrounding portion of the lid, which surrounds the insertion hole, while insulating between the insertion hole surrounding portion of the lid and the terminal member, wherein
of the opening portion of the case body and the peripheral portion of the lid,
for at least proximate long-side opening portions, close to the resin member, of the pair of long-side opening portions and at least proximate long-side peripheral portions, opposing the proximate long-side opening portions and close to the resin member, of the pair of long-side peripheral portions,
a peripheral outer surface of the peripheral portion, facing an outer side in the lid thickness direction, is located on the outer side relative to a melt-solidified portion which is a portion solidified after the opening portion and the peripheral portion are melted and mixed.

5. The power storage device according to claim 4, wherein the peripheral outer surface of the lid is located on the outer side relative to the melt-solidified portion over an entire circumference of the opening portion of the case body and the peripheral portion of the lid.
